(19) United States
(12) Patent Application Publication
(10) Pub. No.: US 2015/0343626 A1
(43) Pub. Date: Dec. 3, 2015

(54) HAMMMER TOOL ASSEMBLY

(71) Applicant: Caterpillar Inc., Peoria, IL (US)

(72) Inventors: JAYARAM GUNASEKARAN, Chennai (IN); Yogesh G. Padwal, Pune (IN); Cody T. Moore, Waco, TX (US); Chetan V. Dahiwal, Chennai (IN); Ashok Rajendran, Chennai (IN); Anuop Udayakumar, Chennai (IN)

(73) Assignee: Caterpillar Inc., Peoria, IL (US)

(21) Appl. No.: 14/824,097

(22) Filed: Aug. 12, 2015

(51) Int. Cl. B25D 9/00; B25D 17/00

(52) U.S. Cl. CPC B25D 9/00; B25D 17/00

(57) ABSTRACT

A hammer tool assembly for a machine is provided. The hammer tool assembly includes a power cell, a tool, and a frame assembly. The frame assembly includes a first side plate and a second side plate. A set of paired blocks are coupled to an inner wall of the first and second side plates respectively. Each of the set of paired blocks includes a plurality of holes configured to receive dowel pins therein. A plurality of mechanical fasteners received through a plurality of openings at any one of the first and second side plates. The plurality of openings of each of the first and second side plates is coaxially aligned with corresponding holes in each of the set of paired blocks respectively. A plurality of mechanical fasteners passes through the aligned holes and extends through the plurality of openings provided at the other of the second and first side plates.

### TECHNICAL FIELD

The present disclosure relates to a work tool assembly of a machine, and more particularly to a hammer tool assembly associated with the machine.

### BACKGROUND

Machines utilize a variety of tools, such as for example a powered hammer, for performing tasks. The hammer may be used in cutting through rocks, demolition of structure etc. The powered hammer generally includes a housing assembly having side plates, a power cell and a tool that extends partially out of housing. The housing is coupled to the power cell by means of bolts. During operation, the tool strikes against various work surfaces resulting in disintegration of material. Due to the impact and load transfer to the hammer during operation, the bolts experience fatigue. Sometimes, the high impact causes bolt failure requiring repair or replacement of the bolts. This may affect an overall operation, efficiency, and productivity of the machine due to increase in machine downtime.

U.S. Pat. No. 7,111,691, hereinafter referred as the '691 patent, describes a crushing hammer, and a fastening element, side plate, and protective casing for the crushing hammer The crushing hammer includes at least two alternative fastening elements with which the hammer can be fastened to a boom of a work machine. The fastening can be done with a separate fastening element equipped with a plane surface for flange mounting and openings for a pin mounting. The fastening elements may further be integrated to the protective casing. However, the '691 patent does not address the issue of load transfer to the fastening elements resulting in fatigue and early failure thereof.

### SUMMARY OF THE DISCLOSURE

In one aspect of the present disclosure, a hammer tool assembly for a machine is provided. A hammer tool assembly includes a power cell that defines a first axis. The hammer tool assembly also includes a tool coupled to one end of the power cell. The hammer tool assembly includes a frame assembly coupled to the power cell. The frame assembly includes a first side plate and a second side plate. The first and second side plates are positioned in surrounding contact with the power cell. The hammer tool assembly includes a set of paired blocks. The set of paired blocks are coupled to an inner wall of the first and second side plates respectively. Further, the set of paired blocks are arranged to surround the power cell. Also, each of the set of paired blocks includes a plurality of holes defined on an inner facing side thereof, the plurality of holes configured to receive dowel pins therein. Further, a plurality of openings is defined on each of the first and second side plates. The plurality of openings of each of the first and second side plates is coaxially aligned with corresponding holes in each of the set of paired blocks respectively. A plurality of mechanical fasteners received through the plurality of openings at any one of the first and second side plates, such that the plurality of mechanical fasteners pass through the aligned holes and extend through the plurality of openings provided at the other of the second and first side plates. The hammer tool assembly is structured and arranged to the boom stick of the machine.

Other features and aspects of this disclosure will be apparent from the following description and the accompanying drawings.

### BRIEF DESCRIPTION OF THE DRAWINGS

FIG. 1 is a side view of an exemplary machine having a hammer tool assembly, according to one embodiment of the present disclosure;

FIG. 2 is a perspective view of the hammer tool assembly of the machine of FIG. 1, according to one embodiment of the present disclosure; and

FIG. 3 is a perspective exploded view of the hammer tool assembly of FIG. 2, according to one embodiment of the present disclosure.

### DETAILED DESCRIPTION

Wherever possible, the same reference numbers will be used throughout the drawings to refer to same or like parts. Moreover, references to various elements described herein are made collectively or individually when there may be more than one element of the same type. However, such references are merely exemplary in nature. Any reference to elements in the singular is also to be construed to relate to the plural and vice-versa without limiting the scope of the disclosure to the exact number or type of such elements unless set forth explicitly.

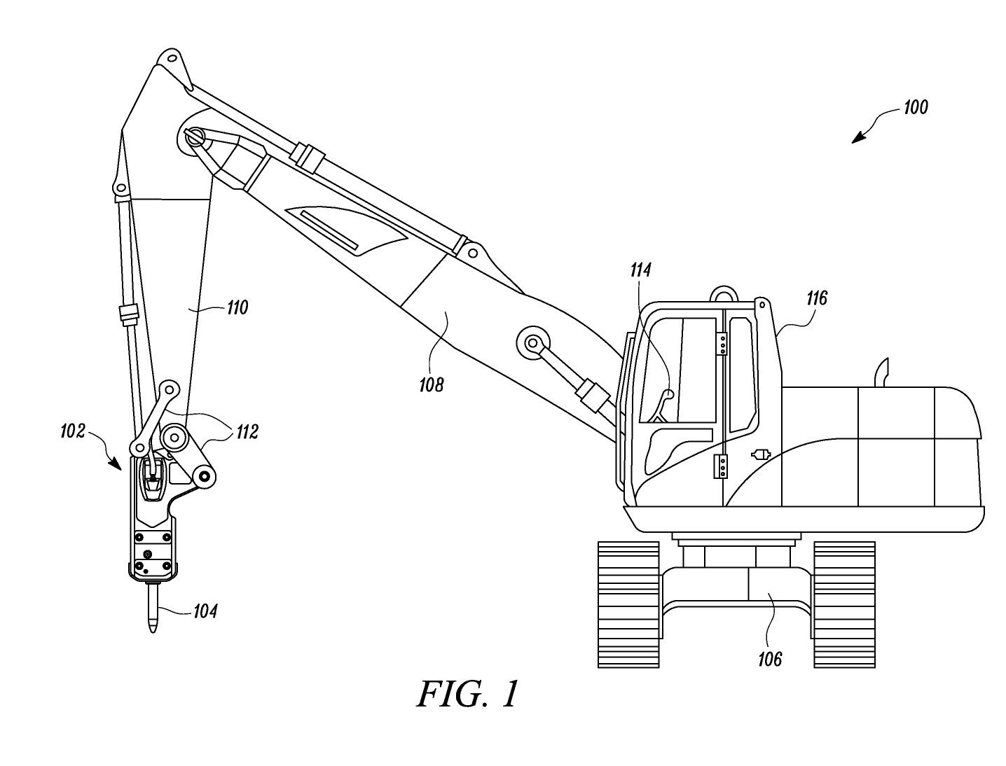

Referring to FIG. 1, an exemplary machine 100 is depicted according to one embodiment of the present disclosure. The machine 100 is embodied as a tracked excavation machine. The machine 100 employs a hammer tool assembly 102. The hammer tool assembly 102 includes a tool 104 for breaking rocks and penetrating ground surfaces. The hammer tool assembly 102 is operated by the excavator's hydraulics. However, it can be optionally contemplated to use other types of machines and carriers to power the hammer tool assembly 102 of the present disclosure.

The machine 100 includes a frame 106, one or more linkages 108, 110, and mounting brackets 112 for connecting the hammer tool assembly 102 to the linkage 110. The linkages 108, 110 are articulated relative to the frame 106 in order to change an orientation and/or position of the hammer tool assembly 102 with respect to a ground surface (not shown). The machine 100 includes an operator control 114 located within a cab 116 of the machine 100. The operator control 114 is used by an operator to operate the hammer tool assembly 102.

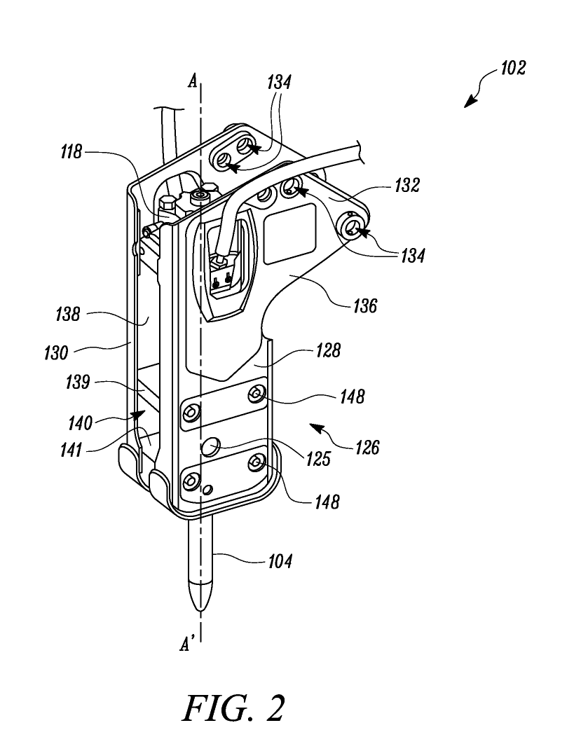

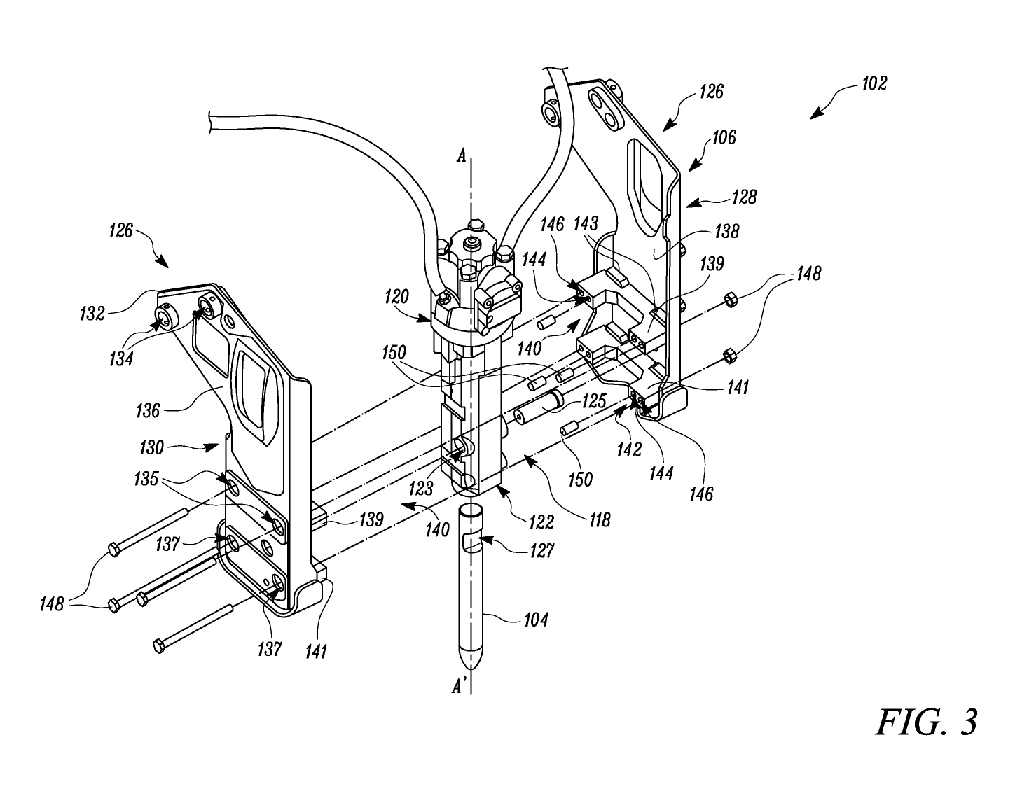

Referring to FIGS. 2 and 3, the hammer tool assembly 102 includes a power cell 118. The power cell 118 has a first end 120 and a second end 122. The first end 120 of the power cell 118 receives pressurized fluid during hammering. The second end 122 of the power cell 118 includes an opening 123. The opening 123 receives a fastener 125 that may be used for the purpose of coupling. The second end 122 includes another opening (not shown) that slidably receives the tool 104. The tool 104 includes a notch 127 provided thereon. The notch 127 on the tool 104 is arranged so that the notch 127 aligns with the opening 123 therethrough.

The power cell 118 is configured to drive the tool 104 of the hammer tool assembly 102 so that the tool 104 performs functions like cutting through rocks, demolition of structure. The power cell 118 defines a first axis A-A′. The first axis A-A′ is the central axis of the hammer tool assembly 102. Referring to FIG. 2, the hammer tool assembly 102 includes a frame assembly 126. The frame assembly 126 is coupled to the power cell 118. The fastener 125 passes through the frame assembly 126 of the hammer tool assembly 102. The frame assembly 126 includes a first side plate 128 and a second side plate 130. The first and second side plates 128, 130 are aligned in a parallel manner with respect to the first axis A-A′. Further, the first and the second side plates 128, 130 are arranged to surround the power cell 118 (see FIG. 3). Each of the first and second side plates 128, 130 include a projecting portion 132 extending in a direction offset with respect to the first axis A-A′. Each of the projecting portions 132 have through holes 134 disposed on them. The through holes 134 couple the hammer tool assembly 102 with the machine 100. Referring to FIG. 3, the first and second side plates 128, 130 have a number of openings 135, 137 provided therethrough.

The first and the second side plates 128, 130 have an outer wall 136 and an inner wall 138. The frame assembly 126 includes two sets of paired blocks 140. The blocks 140 are coupled to the inner walls 138 of the first and second side plates 128, 130.

The blocks 140 are fixedly coupled to the respective inner walls 138 using any known methods such as, welding, riveting, and so on. An adhesive may be used to couple the blocks 140 to the inner walls 138. Positioning elements 143 are provided on the inner walls 138 at top and bottom locations with respective to each of the blocks 140 on the first and second side plates 128, 130. The blocks 140 include a pair of first blocks 139 and a pair of second blocks 141 attached to the respective first and second side plates 128, 130.

Each of the blocks 140 has a C-shaped configuration. The blocks 140 are arranged such that the first and second pairs of blocks 139, 141 are in a surrounding contacting relationship with the power cell 118, such that the power cell 118 is received into a C- portion of the respective block 140. In an example, there may be single or multiple sets of blocks 140 attached to the inner wall 138 of each of the first and second side plates 128, 130. The blocks 140 have a number of holes 142 formed on an inner facing side 138 of the respective blocks 140. The holes 142 are arranged in pairs. Each of the pair of the holes 142 has a first hole 144 and a second hole 146. The second hole 146 provided on the blocks 140 associated with the first and second side plates 128, 130 respectively. The second holes 146 are coaxially aligned with the respective openings 135, 137 of the first and second side plates 128, 130.

Mechanical fasteners 148 are received into the openings 135, 137 provided on second side plate 130 pass through the coaxially aligned second hole 146 of the blocks 140 and extend through the openings 135,137 provided on the first side plate 128. Alternatively, the mechanical fasteners 148 may be arranged in an opposite orientation, passing through the first side plate 128 and extending towards the second side plate 130. In other embodiments, the mechanical fasteners 148 may pass through the first holes 144, instead of the second holes 146 that are illustrated in the accompanying figures.

The respective first holes 144 of the blocks 140 are configured to receive dowel pins 150 therein. Two dowel pins 150 are associated with each block 140. In other embodiments, additional number of dowel pins 150 may be associated with each block 140. The dowel pins 150 are internally bridged within the blocks 140. The dowel pins 150 are high strength direct hardened steel pins. A diametrical clearance between the first holes 144 and the dowel pins 150 is lesser than a diametrical clearance between the mechanical fasteners 148 and the second holes 146. Also, the dowel pins 150 are smaller in length than the mechanical fasteners 148. The dowel pins 150 are positioned between the respective block and the power cell 118.

The construction and design of the hammer tool assembly 102 described herein is exemplary and does not limit the scope of the present disclosure. The blocks 140 may be constructed to include additional number of dowel pins 150 without limiting the scope of the present disclosure.

### INDUSTRIAL APPLICABILITY

The present disclosure relates to the hammer tool assembly 102. The hammer tool assembly 102 includes the first and second side plates 128, 130. The first and second side plates 128, 130 are coupled to the power cell 118 using the mechanical fasteners 148 and the dowel pins 150.

The dowel pins 150 provide strength to the hammer tool assembly 102. As the length of the dowel pins 150 is small in size and thus the dowel pins 150 have lesser tendency to bend when subject to high impact. During the operation of the hammer tool assembly 102, the dowel pins 150 are subjected to impact loads. Due to tighter manufacturing tolerances associated with the dowel pins 150, the dowel pins 150 absorb the impact load and reduce, prevent or eliminate the transfer of impact load to the mechanical fasteners 148. Thus, a fatigue life of the mechanical fasteners 148 is increased, since the mechanical fasteners 148 are not subjected to impact loads. The dowel pins 150 also restricts a movement of the blocks 140, thereby improving rigidity of the hammer tool assembly 102 and preventing the bending of the mechanical fasteners 148.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A hammer tool assembly for a machine, the hammer tool assembly comprising:
a power cell defining a first axis;
a tool coupled to one end of the power cell; and
a frame assembly coupled to the power cell, the frame assembly comprising:
a first side plate and a second side plate, the first and second side plates positioned in surrounding contact with the power cell; and
a set of paired blocks coupled to an inner wall of the first and second side plates respectively, the set of paired blocks arranged to surround the power cell, each of the set of paired blocks including a plurality of holes defined on an inner facing side thereof, the plurality of holes configured to receive dowel pins therein,
wherein a plurality of openings is defined on each of the first and second side plates, wherein the plurality of openings of each of the first and second side plates is coaxially aligned with corresponding holes in each of the set of paired blocks respectively, and wherein a plurality of mechanical fasteners are received through the plurality of openings at any one of the first and second side plates, such that the plurality of mechanical fasteners pass through the aligned holes and extend through the plurality of openings provided at the other of the second and first side plates, where the hammer tool assembly being structured and arranged to the boom stick of the machine.
